(19) United States
(12) Patent Application Publication
(10) Pub. No.: US 2024/0414810 A1
(43) Pub. Date: Dec. 12, 2024

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/696,607

(22) PCT Filed: Sep. 29, 2021
(86) PCT No.: PCT/CN2021/121806

§ 371 Date: Mar. 28, 2024

(51) Int. Cl. H04W 76/34; H04W 76/27; H04W 88/04

(52) U.S. Cl. CPC H04W 76/34; H04W 76/27; H04W 88/04

(57) ABSTRACT

Embodiments of the present disclosure relate to methods, devices and computer readable media for communication. A first device receives, from a second device, a RRC reconfiguration message; and releasing at least one connection between the first device and a third device in response to at least one of the following: the RRC reconfiguration message comprising a first indication, the first indication indicating that the at least one connection is to be released; the RRC reconfiguration message indicating an indirect to direct path switch; or the RRC reconfiguration message indicating a release of at least one of a RLC configuration for relaying or bearer mapping configuration. In this way, a procedure for sidelink release may be provided.

### TECHNICAL FIELD

Embodiments of the present disclosure generally relate to the field of telecommunication, and in particular, to methods, devices and computer storage media of communication for sidelink release in sidelink relay.

### BACKGROUND

In context of new radio (NR) sidelink relay, user equipment (UE) that is communicated with a gNB via another UE in coverage (IC) of the gNB is called as remote UE, and the other UE is called as a relay UE. The remote UE may be out of coverage (OoC) of the gNB, and also may be in coverage of the gNB. A connection is established between the remote UE and the relay UE via a sidelink.

In study of sidelink relay, there is a need to specify mechanisms for service continuity which include indirect to direct path switch. An indirect path means there is a relay UE between a remote UE and a gNB, and a direct path means there is no relay UE between a remote UE and a gNB. For the indirect to direct path switch, a sidelink between a relay UE and a remote UE needs to be released. However, the release of the sidelink is incomplete and to be further developed.

### SUMMARY

In general, embodiments of the present disclosure provide methods, devices and computer storage media of communication for sidelink release in sidelink relay.

In a first aspect, there is provided a method of communication. The method comprises: receiving, at a first device and from a second device, a radio resource control (RRC) reconfiguration message; and releasing at least one connection between the first device and a third device in response to at least one of the following: the RRC reconfiguration message comprising a first indication, the first indication indicating that the at least one connection is to be released; the RRC reconfiguration message indicating an indirect to direct path switch; or the RRC reconfiguration message indicating a release of at least one of a radio link control (RLC) configuration for relaying or bearer mapping configuration.

In a second aspect, there is provided a method of communication. The method comprises: transmitting, at a second device and to a first device, at least one of the following: a RRC reconfiguration message comprising a first indication, the first indication indicating that at least one connection between the first device and a third device is to be released; a RRC reconfiguration message indicating an indirect to direct path switch; or a RRC reconfiguration message indicating a release of at least one of a RLC configuration for relaying or bearer mapping configuration.

In a third aspect, there is provided a device of communication. The device comprises a processor configured to perform the method according to the first aspect of the present disclosure.

In a fourth aspect, there is provided a device of communication. The device comprises a processor configured to perform the method according to the second of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure may be implemented;

FIG. 1B illustrates a schematic diagram of a user plane protocol stack in which some embodiments of the present disclosure can be implemented;

FIG. 1C illustrates a schematic diagram of a control plane protocol stack in which some embodiments of the present disclosure can be implemented;

FIG. 1D illustrates a schematic diagram of a control plane protocol stack for a sidelink control channel (SCCH) for PC5-radio resource control (PC5-RRC) in which some embodiments of the present disclosure can be implemented;

FIG. 1E illustrates a schematic diagram of a control plane protocol stack for SCCH for PC5-signaling (PC5-S) in which some embodiments of the present disclosure can be implemented;

FIG. 2 illustrates a schematic diagram illustrating a process for communication for sidelink release according to embodiments of the present disclosure;

FIG. 3A illustrates a schematic diagram illustrating a process for communication for sidelink release triggered by a PC5-RRC layer according to embodiments of the present disclosure;

FIG. 3B illustrates a schematic diagram illustrating a process for communication for sidelink release triggered by a PC5-S layer according to embodiments of the present disclosure;

FIG. 4 illustrates a schematic diagram illustrating a process for handling a collision for sidelink release according to embodiments of the present disclosure;

FIG. 5A illustrates a schematic diagram illustrating another process for handling a collision for sidelink release according to embodiments of the present disclosure;

FIG. 5B illustrates a schematic diagram illustrating another process for handling a collision for sidelink release according to embodiments of the present disclosure;

FIG. 5C illustrates a schematic diagram illustrating another process for handling a collision for sidelink release according to embodiments of the present disclosure;

FIG. 5D illustrates a schematic diagram illustrating another process for handling a collision for sidelink release according to embodiments of the present disclosure;

FIG. 6 illustrates a flowchart for an example method of communication implemented at a first device in accordance with some embodiments of the present disclosure;

FIG. 7 illustrates a flowchart for an example method of communication implemented at a second device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “remote UE” refers to a terminal device that is communicated with a network device via another terminal device in coverage of the network device. The term “relay UE” refers to a terminal device that is in coverage of a network device and via which remote UE is communication with the network device. The relay UE is connected with the remote UE via a sidelink interface such as a PC5 interface or the like. The term “remote UE” can be used interchangeably with a remote terminal device or a remote device. The term “relay UE” can be used interchangeably with a relay terminal device or a relay device.

For service continuity, in some scenarios, remote UE may be switched from communicating with gNB indirectly via relay UE to communicating with the gNB directly. In some scenarios, remote UE may be switched from communicating with gNB indirectly via relay UE to communicating with the gNB indirectly via another relay UE. For these scenarios, a connection between the remote UE and the relay UE needs to be released.

Embodiments of the present disclosure provide a solution for releasing a connection between remote UE and relay UE. In the solution, in response to receiving, from gNB, an indication indicating that the connection between the remote UE and the relay UE is to be released, the remote UE or the relay UE releases the connection. In some embodiments, the indication may be a RRC reconfiguration indicating an indirect to direct path switch. In some embodiments, the indication may be a RRC reconfiguration indicating a release of at least one of radio link control (RLC) configuration for relaying and bearer mapping configuration. In some embodiments, the indication may be a RRC reconfiguration message comprising the indication. In some embodiments, the remote UE or the relay UE may release the connection via inter-layer interactions among a RRC layer, a PC5-signaling layer and a PC5-RRC layer of the remote UE or the relay UE. In this way, a procedure for releasing a sidelink connection is provided.

Principles and implementations of the present disclosure will be described in detail below with reference to the figures.

### Example of Communication Network

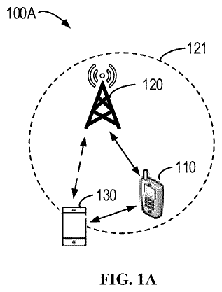

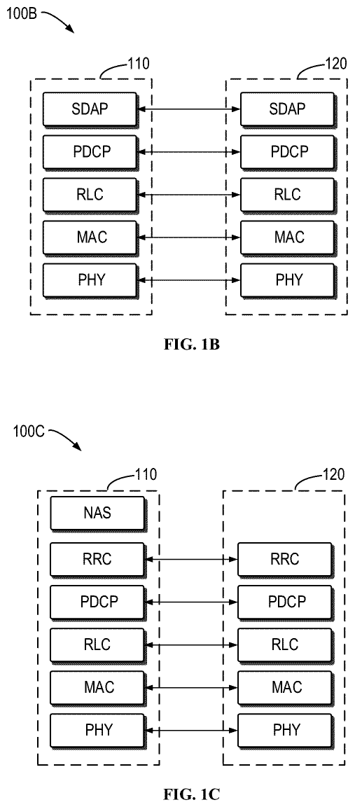

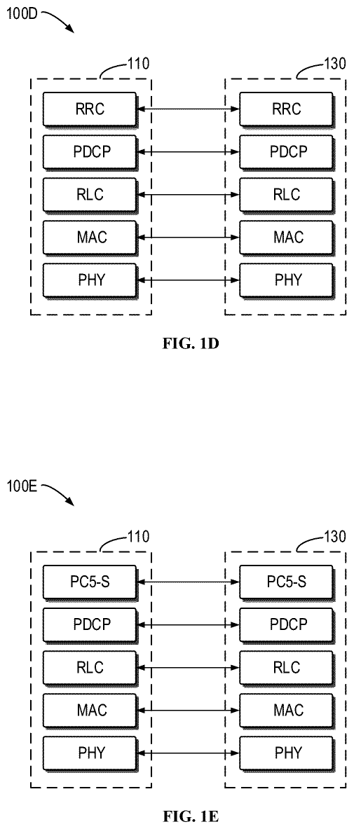

FIG. 1 illustrates a schematic diagram of an example communication network 100 in which some embodiments of the present disclosure can be implemented. As shown in FIG. 1, the communication network 100 may include a first device 110, a second device 120 and a third device 130. The second device 120 provides a cell 121 to serve one or more devices. In the example of FIG. 1, the first device 110 is located within the cell 121 of the second device 120, and the first device 110 may directly communicate with the second device 120. The third device 130 is located outside the cell 121. The third device 130 is connected with the first device 110 via a sidelink interface (for example, PC5 interface or the like) and may communicate with the second device 120 via the first device 110. In this case, the first device 110 is called as a relay device, and the third device 130 is called as a remote device.

In some embodiments, the first device 110 and the second device 120 may communicate with each other via a channel such as a wireless communication channel. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

In some embodiments, the first device 110 and the third device 130 may communicate with each other via a sidelink channel such as a physical sidelink shared channel (PSSCH), a physical sidelink control channel (PSCCH), a physical sidelink feedback channel (PSFCH), a physical sidelink broadcast channel (PSBCH) or the like. For example, a PC5 link or PC5 RRC connection may be established between the first device 110 and the third device 130.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices in FIG. 1 is given for the purpose of illustration without suggesting any limitations to the present disclosure. The communication network 100 may include any suitable number of first devices, second devices or third devices adapted for implementing implementations of the present disclosure.

For illustration, the first device 110 and the third device 130 are shown as terminal devices and the second device 120 is shown as a network device. Merely for illustration purpose and without suggesting any limitations as to the scope of the present disclosure, some embodiments will be described in the context where the first device 110 and the third device 130 are terminal devices and the second device 120 is a network device. In this case, the first device 110 corresponds to a relay UE, and the third device 130 corresponds to a remote UE.

It is to be understood that, in other embodiments, the first device 110 and/or the third device 130 may be a network device and the second device 120 may be a terminal device. In other words, the principles and spirits of the present disclosure can be applied to both uplink and downlink transmissions. Further, in some embodiments, all of the first device 110, the second device 120 and the third device 130 may be terminal devices, and in some embodiments, all of the first device 110, the second device 120 and the third device 130 may be network devices. The present application does not limit this aspect.

The communications between a terminal device and a network device in communication network 100 may be performed in accordance with user plane and control plane protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for user plane protocol stack at devices according to some embodiments of the present disclosure. For illustration, the following description is given by taking the first device 110 as an example of the terminal device and taking the second device 120 as an example of the network device.

As shown in FIG. 1B, in the user plane, each of the first device 110 and the second device 120 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a RLC layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for control plane protocol stack at devices according to some embodiments of the present disclosure. As shown in FIG. 1C, in the control plane, each of the first device 110 and the second device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a RRC layer (also referred to as a RRC entity). The RRC layer may be also referred to as an access stratum (AS) layer, and thus the RRC entity may be also referred to as an AS entity. As shown in FIG. 1C, the first device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, channels between the RRC layer and PDCP layer are called as radio bearers. A terminal device (for example, the first device 110 or the third device 130) may be configured with at least one data radio bearer (DRB) for bearing data plane data and at least one signaling radio bearer (SRB) for bearing control plane data. The RRC layer may be used interchangeably with Uu RRC layer, RRC entity, Uu RRC entity.

The communications between terminal devices in the communication network 100 may be performed in accordance with control plane protocol stacks. FIG. 1D illustrates a schematic diagram 100D of a control plane protocol stack for a SCCH for PC5-RRC in which some embodiments of the present disclosure can be implemented. For illustration, the following description is given by taking the first device 110 and the third device 130 as examples of the terminal devices.

As shown in FIG. 1D, in the control plane, each of the first device 110 and the third device 130 may comprise an entity for the L1 layer, i.e., an entity for a PHY layer (also referred to as a PHY entity), and one or more entities for upper layers (L2 and L3 layers, or upper layers) including an entity for a MAC layer (also referred to as a MAC entity), an entity for a RLC layer (also referred to as a RLC entity), an entity for a PDCP layer (also referred to as a PDCP entity), and an entity for a PC5-RRC layer (also referred to as a PC5-RRC entity). In some cases, the PHY, MAC, RLC, PDCP, PC5-RRC entities are in a stack structure.

In some embodiments, the RRC entity and the PC5-RRC entity may be the same entity (e.g. logical entity). Of course, the RRC entity and the PC5-RRC entity may be different entities (e.g. logical entities). In some embodiments, the RRC layer and the PC5-RRC layer may be realized as the same layer. Of course, the RRC layer and the PC5-RRC layer may be realized as different layers.

FIG. 1E illustrates a schematic diagram 100E illustrating a control plane protocol stack for SCCH for PC5-S in which some embodiments of the present disclosure can be implemented. As shown in FIG. 1E, in the control plane, each of the first device 110 and the third device 130 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a PC5-S layer (also referred to as a PC5-S entity). In some cases, the PHY, MAC, RLC, PDCP, PC5-S entities are in a stack structure.

Generally, the PC5-RRC layer may manage a PC5 RRC connection (e.g. to establish/modify/release sidelink DRBs, to (re-) configure NR sidelink measurement and reporting, to (re-) configure sidelink CSI reference signal resources and CSI reporting latency bound) and the PC5-S layer may manage a PC5 unicast link. In the context of the present disclosure, the PC5 RRC connection may be used interchangeably with a PC5 connection. The PC5 unicast link may be used interchangeably with a PC5 link, Layer-2 link over PC5, PC5 Layer-2 link, Layer-2 link or layer-2 link. The PC5-RRC layer may be used interchangeably with a PC5 RRC entity, PC5 RRC, PC5 RRC layer, PC5-RRC, AS layer, or the lower layer of PC5-S layer. The PC5-S layer may be used interchangeably with a PC5 signaling layer, PC5 signaling sublayer, V2X layer, the upper layer of PC5-RRC layer, the upper layer of RRC layer, or NAS layer. The RRC layer may be used interchangeably with a Uu RRC layer, RRC entity or AS layer. The RRC layer may be used interchangeably with the lower layer of PC5-S layer.

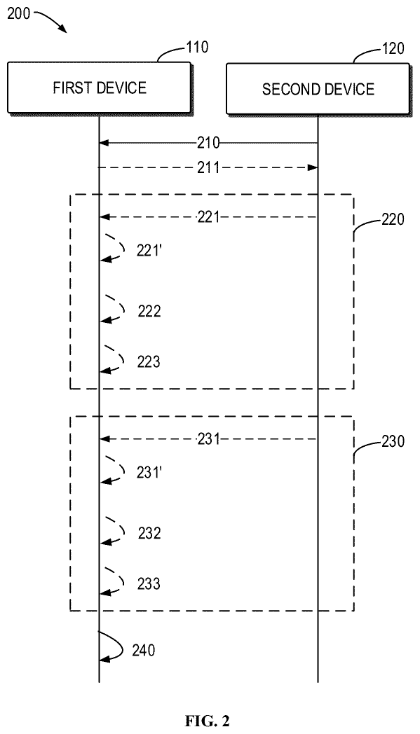

Return to FIG. 1A, in some scenarios, the third device 130 is communicated with the second device 120 via the first device 110 in an earlier stage. As the third device 130 moves, it may enter the coverage of cell 121. In this case, a direct connection may be established with the cell 121, and thus the indirect to direct path switch may be performed. Alternatively, the third device 130 may need to be switched to other device than the first device 110 for service continuity. In these cases, a connection (also referred to as a sidelink connection or PC5 link herein) between the first device 110 and the third device 130 may need to be released. Embodiments of the present disclosure provide solutions for releasing the connection (also referred to as sidelink release or PC5 link release herein). The detailed description will be made below with reference to FIGS. 2 to 5D.

### Example Implementation of Sidelink Release

FIG. 2 illustrates a schematic diagram illustrating a process 200 for communication for sidelink release according to embodiments of the present disclosure. For the purpose of discussion, the process 200 will be described with reference to FIG. 1. The process 200 may involve the first device 110 and the second device 120 as illustrated in FIG. 1. Of course, the same process may also be carried out between the third device 130 and the second device 120 as illustrated in FIG. 1. The steps and the order of the steps in FIG. 2 are merely for illustration, and not for limitation. For example, the order of the steps may be changed. Some of the steps may be omitted or any other suitable additional steps may be added.

As shown in FIG. 2, the second device 120 may transmit 210 a RRC reconfiguration message to the first device 110. For example, when the second device 120 decides to perform an indirect to direct path switch or an indirect to indirect path switch for the third device 130, the second device 120 may transmit the RRC reconfiguration message to the first device 110.

In some embodiments, the RRC reconfiguration message may indicate an indirect to direct path switch. In some embodiments, the RRC reconfiguration message may indicate an indirect to indirect path switch. In some embodiments, the RRC reconfiguration message may indicate a release of RLC configuration for relaying, for example, a release of PC5 RLC or PC5 RLC channel configuration for relaying. In some embodiments, the RRC reconfiguration message may indicate a release of bearer mapping configuration, for example, between Uu RLC and PC5 RLC or between Uu RLC channels and PC5 RLC channels.

In some embodiments, the RRC reconfiguration message may indicate that at least one connection between the first device 110 and the third device 130 is to be released. For example, the at least one connection may comprise at least one PC5 connection or PC5 RRC connection. In some embodiments, the RRC reconfiguration message may comprise an indication (also referred to as a first indication herein) indicating that the at least one connection is to be released. In some embodiments, the first indication may be comprised in the RRC reconfiguration message as an information element (IE). In some embodiments, the IE may be associated with the first device 110 or a type of the first device 110. The type may indicate whether the first device 110 is relay UE or remote UE. In some embodiments, the IE may be associated with a protocol layer (such as PC5-S, or PC5-RRC) of the first device 110. In some embodiments, the first indication may be comprised in a RRC container in the RRC reconfiguration message. In some embodiments, the RRC container may be associated with the first device 110 or a type of the first device 110. The type may indicate whether the first device 110 is relay UE or remote UE. In some embodiments, the RRC container may be associated with a protocol layer (such as PC5-S, or PC5-RRC) of the first device 110. In some embodiments, the first indication may be comprised in the RRC reconfiguration message as a field. In some embodiments, the first indication and the RRC Reconfiguration message may be transmitted in the same RRC message, but the first indication is not comprised by this RRC Reconfiguration message.

In some embodiments, the first indication may comprise information of the at least one connection. In some embodiments, the first indication may comprise information (also referred to as first information herein) of at least one link associated with the at least one connection (e.g. the connection between the first device 110 and the third device 130). For example, the at least one link may comprise at least one PC5 link or PC5 unicast link. In some embodiments, there is one-to-one correspondence between each connection of the at least one connection and each link of the at least one link. Of course, one connection may correspond to multiple links.

In some embodiments, the first information may comprise an identity of each of the at least one link. In some embodiments, the identity may have 8 N bits, where N is a positive integer. For example, the identity may have 48 bits, 32 bits or the like. In some embodiments, the first information may comprise a layer 2 identifier (ID) for each of the at least one link. In some embodiments, the first information may comprise a PC5 link ID for each of the at least one link. In some embodiments, the first information may comprise source and destination IDs for each of the at least one link. In some embodiments, the first information may comprise a pair of (source ID, destination ID) for each of the at least one link. In some embodiments, the first information may comprise a source ID for each of the at least one link. In some embodiments, the first information may comprise a destination ID for each of the at least one link.

In some embodiments, the second device 120 may transmit the first indication respectively for each destination. For example, the destination may be associated with the at least one link. As another example, the destination may be associated with the at least one connection. In some embodiments, the second device 120 may transmit the first indication once for all destinations or PC5 links or PC5 unicast links or PC5-RRC connections or PC5 connections. For example, the first indication may comprise one reserved or predefined Layer-2 ID or PC5 link identifier or a pair of (source ID, destination ID) for all destinations. As another example, the first indication may comprise a list of Layer 2 ID or PC5 link identifier or a pair of (source ID, destination ID) for all destinations.

In some embodiments, the first device 110 may transmit 211, to the second device 120, information (also referred to as second information herein) indicating that one or more links or connections, are established between the first device 110 and the third device 130. For example, the first device 110 may transmit the second information to the second device 120 via a RRC message (e.g. SidelinkUEInformationNR message) so as to report the establishment of one or more links. Of course, the second information may be transmitted in any other suitable ways. With the second information, the second device 120 may know information of links between the first device 110 and the third device 130, and then generate the first indication efficiently. In some embodiments, the second information may be transmitted via a layer-2 message.

With reference to FIG. 2, upon receipt of the RRC reconfiguration message, the first device 110 may determine 220 whether the releasing is performed by the first device 110. That is, the first device 110 may determine whether to release the at least one connection between the first device 110 and the third device 130.

In some embodiments, the first device 110 may receive 221, from the second device 120, an indication (also referred to as a sixth indication herein) indicating that the releasing of the at least one connection between the first device 110 and the third device 130 is performed by the first device 110. In some embodiments, the sixth indication may be transmitted via an IE or a field or a RRC container. For example, only one IE or one field or one RRC container is used for the indication the first device or the type (e.g. relay UE or remote UE) of the first device. As another example, two IEs or two fields or two RRC containers are used for the indication of different types of device, such as relay UE or remote UE, respectively. In some embodiments, the sixth indication may comprise at least one of an identity (e.g., Layer-2 ID, cell-radio network temporary identifier (C-RNTI), inactive-radio network temporary identifier (I-RNTI) or 5G-S-temporary mobile subscription identifier (5G-S-TMSI) or the type of the first device 110). In some embodiments, the identity may have 8 N bits, where N is a positive integer. For example, the identity may have 48 bits, 32 bits or the like. In this case, the first device 110 may determine 221′ to release the at least one connection. With the sixth indication, it is explicitly specified which one of the first device 110 and the third device 130 performs PC5 link release. Thus, collision for PC5 link release between the first device 110 and the third device 130 may be avoided.

In some embodiments, if determining that the first indication is comprised in the IE for the first device 110 or for the type of the first device 110, the first device 110 may determine 222 to release the at least one connection. In some embodiments, if determining that the first indication is comprised in the RRC container for the first device 110 or for the type of the first device 110, the first device 110 may determine 223 to release the at least one connection. It this way, it is implicitly specified which one of the first device 110 and the third device 130 performs PC5 link release. Thus, collision for PC5 link release between the first device 110 and the third device 130 may also be avoided.

Still with reference to FIG. 2, upon determining to release the at least one connection, the first device 110 may determine 230 whether a PC5-RRC layer (also referred to as a second protocol layer herein) or a PC5-S layer (also referred to as a third protocol layer herein) of the first device 110 is triggered to perform the releasing. In some embodiments, the first device 110 may determine, based on UE implementation, one of a PC5-RRC or PC5-S layer to perform the releasing. In some embodiments, it is preconfigured whether a PC5-RRC layer or a PC5-S layer is triggered to perform the releasing. In some embodiments, it is predefined whether a PC5-RRC layer or a PC5-S layer is triggered to perform the releasing.

In some embodiments, the first device 110 may receive 231 an indication (also referred to as a fifth indication herein) indicating whether the releasing is triggered by a PC5-RRC or PC5-S layer, and determine 231′ whether a PC5-RRC layer or a PC5-S layer is triggered or indicated or requested to perform the releasing based on the indication. In some embodiments, the fifth indication may comprise an IE or a field or a RRC container. For example, only one IE or one field or one RRC container is used for the indication of both PC5-RRC layer and PC5-S layer. As another example, two IEs or two fields or two RRC containers are used for the indication of PC5-RRC layer and PC5-S layer respectively. In some embodiments, if determining that the fifth indication appears or is present, the first device 110 may determine 232 that the PC5-RRC layer is triggered to perform the releasing. In some embodiments, if determining that the fifth indication doesn't appear, the first device 110 may determine 232 that the PC5-RRC layer is not triggered to perform the releasing, while PC5-S layer is trigger to perform the releasing. In some embodiments, if determining that the fifth indication appears, the first device 110 may determine 232 that the PC5-S layer is triggered to perform the releasing. In some embodiments, if determining that the fifth indication doesn't appear, the first device 110 may determine 232 that the PC5-S layer is not triggered to perform the releasing, while the PC5-RRC layer is triggered to perform the releasing.

In some embodiments, if determining that the first indication is comprised in an IE or a field or a RRC container for the PC5-RRC layer, the first device 110 may determine 232 that the PC5-RRC layer is triggered to perform the releasing. In some embodiments, if determining that the first indication is comprised in an IE or a field or a RRC container for the PC5-S layer, the first device 110 may determine 233 that the PC5-S layer is triggered to perform the releasing.

Accordingly, the first device 110 releases 240 the at least one connection. The detailed description on the releasing of the at least one connection will be given in connection with Embodiments 1-2.

### Embodiment 1

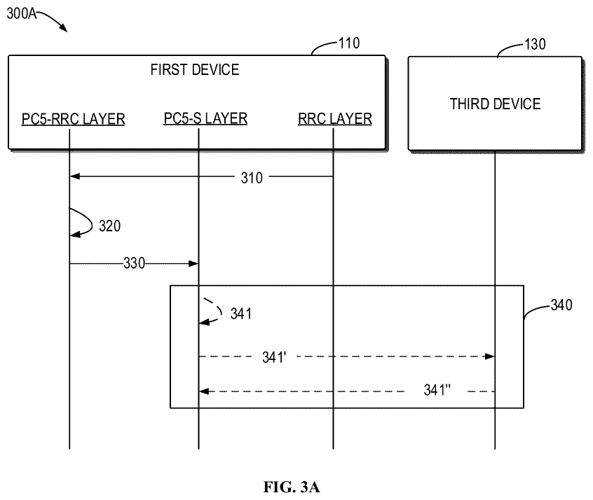

In this embodiment, a procedure to trigger PC5 link release is provided. Some example embodiments will be described with reference to FIGS. 3A and 3B.

FIG. 3A illustrates a schematic diagram illustrating a process 300A for communication for sidelink release triggered by a PC5-RRC layer according to embodiments of the present disclosure. For the purpose of discussion, the process 300A will be described with reference to FIG. 1. The process 300A may involve the first device 110 and the third device 130 as illustrated in FIG. 1. In this example, the first device 110 is relay UE and the third device 130 is remote UE. It is to be understood that the process 300A may also apply to the case that the first device 100 is remote UE and the third device 130 is relay UE. The steps and the order of the steps in FIG. 3A are merely for illustration, and not for limitation. For example, the order of the steps may be changed. Some of the steps may be omitted or any other suitable additional steps may be added.

As shown in FIG. 3A, upon receipt of the RRC reconfiguration message from the second device 120, a RRC layer (also referred to as a first protocol layer herein) of the first device 110 may transmit 310, to a PC5-RRC layer (also referred to as a second protocol layer herein) of the first device 110, an indication (also referred to as a second indication herein) indicating that the at least one connection between the first device 110 and the third device 130 is to be released. In other words, the RRC layer may indicate or request the PC5-RRC layer to release the at least one connection.

In some embodiments, the second indication may comprise an ID of at least one link associated with the at least one connection. In some embodiments, the second indication may comprise an ID of a destination. For example, the destination may be associated with the at least one link. As another example, the destination may be associated with the at least one connection. In some embodiments, the second indication may comprise a source ID and a destination ID for each of the at least one link. In other words, each link may correspond to a pair of (source ID, destination ID).

In some embodiments, the RRC layer may transmit the second indication respectively for each destination. In some embodiments, the RRC layer may transmit the second indication once for all destinations. For example, the second indication may comprise one reserved or predefined Layer-2 ID or PC5 link identifier or a pair of (source ID, destination ID) for all destinations. As another example, the second indication may comprise a list of Layer-2 ID or PC5 link identifier or a pair of (source ID, destination ID) for all destinations.

In some embodiments, the RRC layer may transmit the second indication upon receipt of the RRC reconfiguration message from the second device 120. In some embodiments, the RRC layer may transmit the second indication upon or after transmission of a RRC reconfiguration complete message. In some embodiments, the RRC layer may transmit the second indication upon or after performance of a connection reconfiguration for sidelink (also referred to as a PC5 connection reconfiguration herein). The performance of the PC5 connection reconfiguration is to release PC5 RLC (e.g. PC5 RLC configuration or PC5 RLC channel(s)) for relaying. For example, the RRC layer may transmit the second indication after receiving RRCReconfigurationCompleteSidelink message for the release of PC5 RLC for relaying.

In some embodiments where the RRC reconfiguration message comprises the first indication, the RRC layer may forward the first indication as the second indication to the PC5-RRC layer.

With reference to FIG. 3A, upon receipt of the second indication, the PC5-RRC layer may release 320 a set of radio bearers (RBs) associated with the at least one connection. In some embodiments, the PC5-RRC layer may release one or more RBs for each of the at least one connection. For example, the PC5-RRC layer may release all SRBs and DRBs for a specific destination or destination ID associated with each connection.

The PC5-RRC layer may transmit 330, to a PC5-S layer (also referred to as a third protocol layer herein) of the first device 110, an indication (also referred to as a third indication herein) indicating that the at least one connection is released or has been released. In other words, the PC5-RRC layer may indicate or request the PC5-S layer to release the at least one connection. In some embodiments, for each of the at least one connection, the PC5-RRC layer may transmit the indication respectively.

Upon receipt of the third indication, the PC5-S layer may release 340 at least one link associated with the at least one connection. In other words, upon requested or indicated by the PC5-RRC layer, the PC5-S layer may release 340 at least one link associated with the at least one connection. In some embodiments, the PC5-S layer may locally release 341 the at least one link. For example, the PC5-S layer may delete all context data associated with the at least one link. In this way, the releasing of the at least one link may be carried out by the first device 110.

In some embodiments, the PC5-S layer may transmit 341′, to the third device 130, a request for releasing the at least one link. For example, the PC5-S layer may transmit a Disconnect Request message to the third device 130. As another example, the PC5-S layer may delete all context data associated with the at least one link. In some embodiments, the PC5-S layer may receive 341″, from the third device 130, a response to the request. For example, the PC5-S layer may receive a Disconnect Response message from the third device 130. As another example, the PC5-S layer of the third device 130 may delete all context data associated with the at least one link. In this way, the releasing of the at least one link may be carried out by both the first device 110 and the third device 130.

So far, a procedure of sidelink release triggered by a PC5-RRC layer is provided. The following description will be made on a procedure of sidelink release triggered by a PC5-S layer with reference to FIG. 3B.

FIG. 3B illustrates a schematic diagram illustrating a process 300B for communication for sidelink release triggered by a PC5-S layer according to embodiments of the present disclosure. For the purpose of discussion, the process 300B will be described with reference to FIG. 1. The process 300B may involve the first device 110 and the third device 130 as illustrated in FIG. 1. In this example, the first device 110 is relay UE and the third device 130 is remote UE. It is to be understood that the process 300B may also apply to the case that the first device 100 is remote UE and the third device 130 is relay UE. The steps and the order of the steps in FIG. 3B are merely for illustration, and not for limitation. For example, the order of the steps may be changed. Some of the steps may be omitted or any other suitable additional steps may be added.

As shown in FIG. 3B, upon receipt of the RRC reconfiguration message from the second device 120, a RRC layer (also referred to as a first protocol layer herein) of the first device 110 may transmit 350, to a PC5-S layer (also referred to as a third protocol layer herein) of the first device 110, an indication (also referred to as a second indication herein) indicating that the at least one connection between the first device 110 and the third device 130 is to be released. In other words, the RRC layer may indicate or request the PC5-S layer to release the at least one connection.

In some embodiments, the second indication may comprise an ID of at least one link associated with the at least one connection. In some embodiments, the second indication may comprise an ID of a destination. For example, the destination may be associated with the at least one link. As another example, the destination may be associated with the at least one connection. In some embodiments, the second indication may comprise a source ID and a destination ID for each of the at least one link. In other words, each link may correspond to a pair of (source ID, destination ID).

In some embodiments, the RRC layer may transmit the second indication respectively for each destination. In some embodiments, the RRC layer may transmit the second indication once for all destinations. For example, the second indication may comprise one reserved or predefined Layer-2 ID or PC5 link identifier or a pair of (source ID, destination ID) for all destinations. As another example, the second indication may comprise a list of Layer-2 ID or PC5 link identifier or a pair of (source ID, destination ID) for all destinations.

In some embodiments, the RRC layer may transmit the second indication upon receipt of the RRC reconfiguration message from the second device 120. In some embodiments, the RRC layer may transmit the second indication upon or after transmission of a RRC reconfiguration complete message. In some embodiments, the RRC layer may transmit the second indication upon or after performance of a connection reconfiguration for sidelink (also referred to as a PC5 connection reconfiguration herein). The performance of the PC5 connection reconfiguration is to release PC5 RLC for relaying. For example, the RRC layer may transmit the second indication after receiving RRCReconfigurationCompleteSidelink message for the release of PC5 RLC for relaying.

In some embodiments where the RRC reconfiguration message comprises the first indication, the RRC layer may forward the first indication as the second indication to the PC5-S layer.

With reference to FIG. 3B, upon receipt of the second indication, the PC5-S layer may release 360 at least one link associated with the at least one connection. In other words, upon requested or indicated by the RRC layer, the PC5-S layer may release 360 at least one link associated with the at least one connection. In some embodiments, the PC5-S layer may locally release 361 the at least one link. In this way, the releasing of the at least one link may be carried out by the first device 110.

In some embodiments, the PC5-S layer may transmit 361′, to the third device 130, a request for releasing the at least one link. For example, the PC5-S layer may transmit a Disconnect Request to the third device 130. In some embodiments, the PC5-S layer may receive 361″, from the third device 130, a response to the request. For example, the PC5-S layer may receive a Disconnect Response from the third device 130. In this way, the releasing of the at least one link may be carried out by both the third device 130 and the first device 110.

Then the PC5-S layer may transmit 370, to a PC5-RRC layer (also referred to as a second protocol layer herein) of the first device 110, an indication (also referred to as a fourth indication herein) indicating that the at least one link is released or has been released. In other words, the PC5-S layer may indicate or request the PC5-RRC layer to release the at least one connection. In some embodiments, for each of the at least one link, the PC5-S layer may transmit the indication respectively.

Upon receipt of the fourth indication, the PC5-RRC layer may release 380 a set of RBs associated with the at least one connection. In other words, upon requested or indicated by the PC5-S layer, the PC5-RRC layer may release at least one link associated with the at least one connection. In some embodiments, the PC5-RRC layer may release one or more RBs for each of the at least one connection. For example, the PC5-RRC layer may release all SRBs and DRBs for a specific destination or destination ID associated with each connection.

In this way, a procedure of sidelink release triggered by a PC5-S layer is provided.

### Embodiment 2

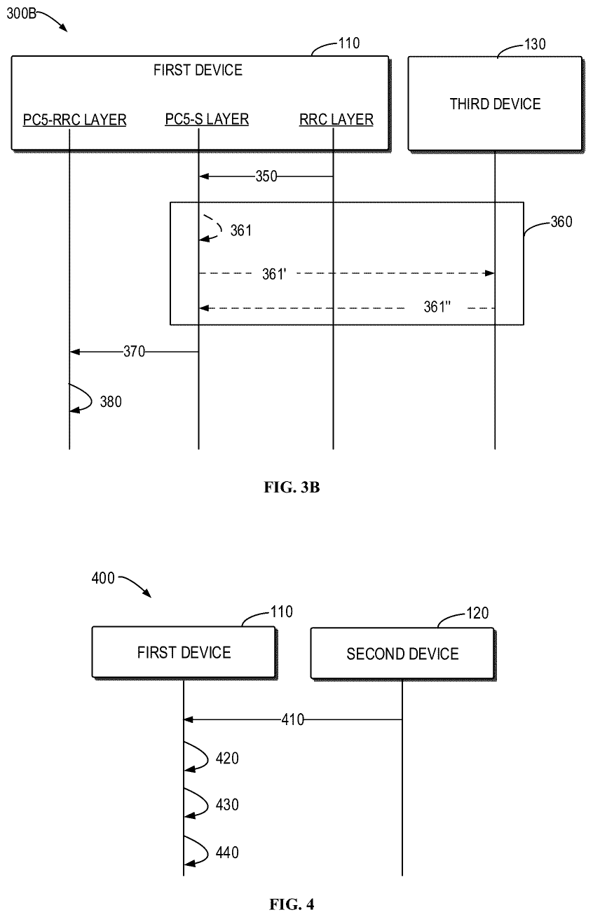

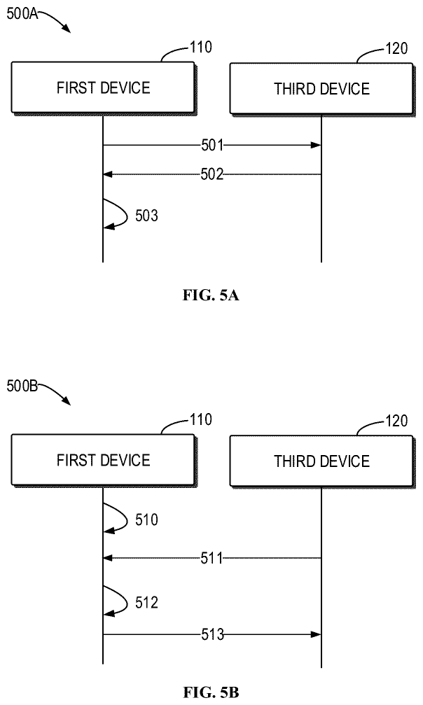

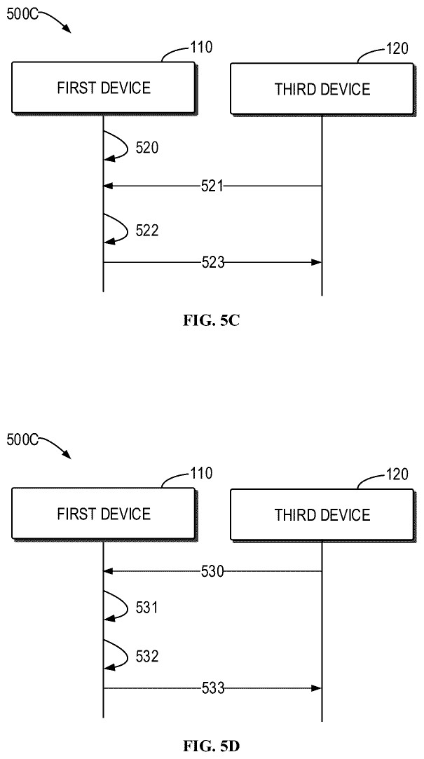

In some scenarios, both relay UE and remote UE may initial PC5 link release after receiving the RRC reconfiguration message. In this case, one PC5 link may be released twice. A solution for handling such collision for PC5 link release is specifying which one of relay UE and remote UE performs the PC5 link release, which has been described in Embodiment 1. Embodiment 2 provides some alternative solutions for handling such collision for PC5 link release. The detailed description is given in connection with FIGS. 4 to 5D.

FIG. 4 illustrates a schematic diagram illustrating a process 400 for handling a collision for sidelink release according to embodiments of the present disclosure. For the purpose of discussion, the process 400 will be described with reference to FIG. 1. The process 400 may involve the first device 110 and the second device 120 as illustrated in FIG. 1. Of course, the same process may also be carried out between the third device 130 and the second device 120 as illustrated in FIG. 1. The steps and the order of the steps in FIG. 4 are merely for illustration, and not for limitation. For example, the order of the steps may be changed. Some of the steps may be omitted or any other suitable additional steps may be added.

In some cases, remote UE transmitting a RRC reconfiguration complete message may be before relay UE receiving a RRC reconfiguration message. It means that remote UE initiates PC5 unicast link release firstly. Then when relay UE receives RRC reconfiguration message, both PC5 unicast link and PC5-RRC connection have been released. In some cases, relay UE transmitting a RRC reconfiguration complete message may be before remote UE receiving a RRC reconfiguration message. It means that relay UE initiates PC5 unicast link release firstly. Then when remote UE receives RRC reconfiguration message, both PC5 unicast link and PC5-RRC connection have been released. For these cases, the process 400 may be performed at remote UE or relay UE. The description is made by taking relay UE (the first device 110) as an example.

As shown in FIG. 4, the second device 120 may transmit 410 a RRC reconfiguration message to the first device 110. The operation of the transmission is similar to that described above in connection with 210 in FIG. 2, and thus is not repeated here for concise.

Upon receipt of the RRC reconfiguration message from the second device 120, the first device 110 may determine 420 whether the at least one link associated with the at least one connection is present. If determining that the at least one link is present, the first device 110 may release 430 the at least one connection. The operation of the releasing is similar to that described above in connection with FIGS. 3A and 3B, and thus is not repeated here for concise.

If determining that the at least one link is not present, the first device 110 may ignore 440 the releasing of the at least one connection. In this way, repeatedly performance of PC5 link release may be avoided.

FIG. 5A illustrates a schematic diagram illustrating another process 500A for handling a collision for sidelink release according to embodiments of the present disclosure. For the purpose of discussion, the process 500A will be described with reference to FIG. 1. The process 500A may involve the first device 110 and the third device 130 as illustrated in FIG. 1. In this example, the first device 110 is relay UE and the third device 130 is remote UE. It is to be understood that the process 500A may also apply to the case that the first device 100 is remote UE and the third device 130 is relay UE. The steps and the order of the steps in FIG. 5A are merely for illustration, and not for limitation. For example, the order of the steps may be changed. Some of the steps may be omitted or any other suitable additional steps may be added.

In this example, assuming that the PC5-RRC layer of the first device 110 and the PC5-RRC layer of the third device 130 request the respective PC5-S layers to initial PC5 link release at the same time, and both the first device 110 and the third device 130 initiate a Layer 2 link release procedure.

As shown in FIG. 5A, the first device 110 may transmit 501 a message (for example, Disconnect Request message) for requesting to disconnect at least one connection between the first device 110 and the third device 130. After the transmission of the message, the first device 110 may receive 502, from the third device 120, a further message (for example, Disconnect Request message) for requesting to disconnect the at least one connection. In this case, the first device 110 may ignore 503 the further message. That is, the first device 110 makes no response to the further message. In this way, the PC5 link release will be performed by the first device 110.

FIG. 5B illustrates a schematic diagram illustrating another process 500B for handling a collision for sidelink release according to embodiments of the present disclosure. For the purpose of discussion, the process 500B will be described with reference to FIG. 1. The process 500B may involve the first device 110 and the third device 130 as illustrated in FIG. 1. In this example, the first device 110 is relay UE and the third device 130 is remote UE. It is to be understood that the process 500B may also apply to the case that the first device 100 is remote UE and the third device 130 is relay UE. The steps and the order of the steps in FIG. 5B are merely for illustration, and not for limitation. For example, the order of the steps may be changed. Some of the steps may be omitted or any other suitable additional steps may be added.

In this example, assuming that the PC5-RRC layer of the first device 110 and the PC5-RRC layer of the third device 130 request the respective PC5-S layers to initial PC5 link release at the same time, and both the first device 110 and the third device 130 initiate a Layer 2 link release procedure.

As shown in FIG. 5B, the first device 110 may generate 510 a message (for example, Disconnect Request message) for requesting to disconnect at least one connection between the first device 110 and the third device 130. However, the message is not transmitted yet. At this time, the first device 110 may receive 511, from the third device 120, a further message (for example, Disconnect Request message) for requesting to disconnect the at least one connection. In this case, the first device 110 may cancel 512 the generated message, and transmit 513 a response to the further message to the third device 130. In this way, the PC5 link release will be performed by the third device 130.

FIG. 5C illustrates a schematic diagram illustrating another process 500C for handling a collision for sidelink release according to embodiments of the present disclosure. For the purpose of discussion, the process 500C will be described with reference to FIG. 1. The process 500C may involve the first device 110 and the third device 130 as illustrated in FIG. 1. In this example, the first device 110 is relay UE and the third device 130 is remote UE. It is to be understood that the process 500C may also apply to the case that the first device 100 is remote UE and the third device 130 is relay UE. The steps and the order of the steps in FIG. 5C are merely for illustration, and not for limitation. For example, the order of the steps may be changed. Some of the steps may be omitted or any other suitable additional steps may be added.

In this example, assuming that the PC5-RRC layer of the first device 110 and the PC5-RRC layer of the third device 130 request the respective PC5-S layers to initial PC5 link release at the same time, and both the first device 110 and the third device 130 initiate a Layer 2 link release procedure.

As shown in FIG. 5C, the first device 110 may generate 520 a message (for example, Disconnect Request message) for requesting to disconnect at least one connection between the first device 110 and the third device 130. However, the message is not transmitted yet. At this time, the first device 110 may receive 521, from the third device 120, a further message (for example, Disconnect Request message) for requesting to disconnect the at least one connection. In this case, the first device 110 may ignore 522 the further message, and transmit 523 the generated message to the third device 130. Then the first device 110 may receive, from the third device 130, a response to the message (for example, Disconnect Response message) transmitted by the first device 110. In this way, the PC5 link release will be performed by the first device 110.

FIG. 5D illustrates a schematic diagram illustrating another process 500D for handling a collision for sidelink release according to embodiments of the present disclosure. For the purpose of discussion, the process 500D will be described with reference to FIG. 1. The process 500D may involve the first device 110 and the third device 130 as illustrated in FIG. 1. In this example, the first device 110 is relay UE and the third device 130 is remote UE. It is to be understood that the process 500D may also apply to the case that the first device 100 is remote UE and the third device 130 is relay UE. The steps and the order of the steps in FIG. 5D are merely for illustration, and not for limitation. For example, the order of the steps may be changed. Some of the steps may be omitted or any other suitable additional steps may be added.

In this example, assuming that the PC5-RRC layer of the first device 110 and the PC5-RRC layer of the third device 130 request the respective PC5-S layers to initial PC5 link release at the same time, and both the first device 110 and the third device 130 initiate a Layer 2 link release procedure.

As shown in FIG. 5D, the first device 110 may receive 530, from the third device 130, a message (for example, Disconnect Request message) for requesting to disconnect at least one connection between the first device 110 and the third device 130. The first device 110 may determine 531 whether at least one link associated with the at least one connection is present. If determining that the at least one link is not present, the first device 110 may ignore 532 the message. That is, the first device 110 makes no response to the message. In this case, the PC5 link release has been performed by the third device 110.

If determining that the at least one link is present, the first device 110 may transmit 533 a response to the message. In this way, the PC5 link release will be performed by the first device 110.

With the processes of FIGS. 5A to 5D, rule of signaling is defined so that repeatedly performance of PC5 link release may be avoided.

### Example Implementation of Methods

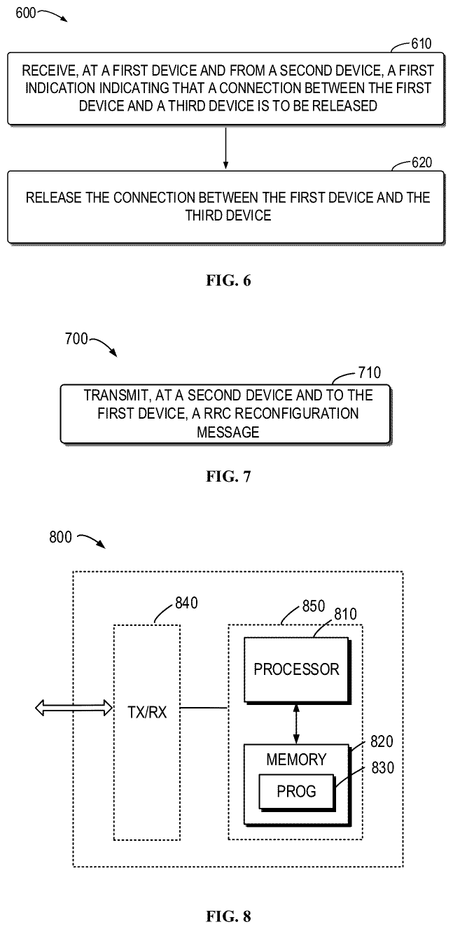

Accordingly, embodiments of the present disclosure provide methods of communication implemented at a terminal device (remote UE or relay UE) and a network device. These methods will be described below with reference to FIGS. 6 to 7.

FIG. 6 illustrates an example method 600 of communication implemented at a first device as relay UE or remote UE in accordance with some embodiments of the present disclosure. For example, the method 600 may be performed at the first device 110 or the third device 130 as shown in FIG. 1. For the purpose of discussion, in the following, the method 600 will be described with reference FIG. 1 and by taking the first device 110 as an example. It is to be understood that the method 600 may include additional blocks not shown and/or may omit some blocks as shown, and the scope of the present disclosure is not limited in this regard.

At block 610, the first device 110 receives, from the second device 120, a RRC reconfiguration message.

At block 620, the first device 110 releases at least one connection between the first device 110 and the third device 130 in response to at least one of the following: the RRC reconfiguration message comprising a first indication, the first indication indicating that the at least one connection is to be released; the RRC reconfiguration message indicating an indirect to direct path switch; or the RRC reconfiguration message indicating a release of at least one of a RLC configuration for relaying or bearer mapping configuration.

In some embodiments, the first indication may be comprised in the RRC reconfiguration message as an IE. In some embodiments, the first indication may be comprised in a RRC container in the RRC reconfiguration message.

In some embodiments, the first device 110 may release the at least one connection by: transmitting, from a first protocol layer of the first device to a second protocol layer of the first device, a second indication indicating the at least one connection is to be released; releasing, by the second protocol layer, a set of radio bearers associated with the at least one connection; transmitting, from the second protocol layer to a third protocol layer of the first device, a third indication indicating that the at least one connection is released; and releasing, by the third protocol layer, at least one link associated with the at least one connection. In this way, sidelink releasing may be triggered by the second protocol layer.

In some embodiments, the first device 110 may release the at least one connection by: transmitting, from a first protocol layer of the first device to a third protocol layer of the first device, a second indication indicating the at least one connection is to be released; releasing, by the third protocol layer, at least one link associated with the at least one connection; transmitting, from the third protocol layer to a second protocol layer of the first device, a fourth indication indicating that the at least one link is released; and releasing, by the second protocol layer, a set of radio bearers associated with the at least one connection. In this way, sidelink releasing may be triggered by the third protocol layer.

In some embodiments, the first device 110 may release the at least one link by: transmitting, from the third protocol layer to the third device, a request for releasing the at least one link, or releasing the at least one link locally by the third protocol layer.

In some embodiments, the second indication may comprise at least one of the following: an identifier of the at least one link, an identifier of a destination, or an identifier of a source and an identifier of a destination for each of the at least one link.

In some embodiments, the second indication may comprise one of the following: transmitting the second indication upon receipt of the RRC reconfiguration message from the second device; transmitting the second indication upon or after transmission of a RRC reconfiguration complete message; or transmitting the second indication upon or after performance of a connection reconfiguration for sidelink.

In some embodiments, the first device 110 may further determine whether a second protocol layer or a third protocol layer of the first device is triggered to perform the releasing. In some embodiments, the first device 110 may receive, from the second device 120, a fifth indication indicating whether the releasing is triggered by the second protocol layer or the third protocol layer; and determine, based on the fifth indication, whether the releasing is triggered by the second protocol layer or the third protocol layer. In some embodiments, if the first indication is comprised in an IE or a RRC container for the second protocol layer, the first device 110 may determine that the releasing is triggered by the second protocol layer. In some embodiments, if the first indication is comprised in an IE or a RRC container for the third protocol layer, the first device 110 may determine that the releasing is triggered by the third protocol layer.

In some embodiments, the first indication may comprise first information of at least one link associated with the at least one connection. In these embodiments, the first device 110 may release the connection by releasing the at least one link. In some embodiments, the first information may comprise a layer 2 identifier, PC5 link identifier or source and destination identifiers for each of the at least one link.

In some embodiments, the first device 110 may also transmit, to the second device 120, second information indicating that one or more links are established between the first device 110 and the third device 130.

In some embodiments, the first device 110 may release the at least one connection by: releasing the at least one connection in response to receiving, from the second device, a sixth indication indicating that the releasing of the at least one connection is performed by the first device. In some embodiments, the sixth indication may comprise at least one of an identity or type of the first device 110. In some embodiments, if the first indication is comprised in an IE or a RRC container for the first device 110 or for the type of the first device 110, the first device 110 may release the at least one connection.

In some embodiments, the first device 110 may determine whether at least one link associated with the at least one connection is present. If the at least one link is present, the first device 110 may release the at least one connection. In some embodiments, if the at least one link is not present, the first device 110 may ignore the releasing of the at least one connection.

In some embodiments, after a second message for requesting to disconnect the at least one connection is transmitted from the first device 110 to the third device 130, if the first device 110 receives, from the third device 130, a first message for requesting to disconnect the at least one connection, the first device 110 may ignore the first message.

In some embodiments, in response to receiving, from the third device 130, a first message for requesting to disconnect the at least one connection upon generation of a second message for requesting to disconnect the at least one connection to be transmitted to the third device 130, the first device 110 may cancel the second message, and transmit, to the third device, a response to the first message.

In some embodiments, in response to receiving, from the third device 130, a first message for requesting to disconnect the at least one connection upon generation of a second message for requesting to disconnect the at least one connection to be transmitted to the third device, the first device 110 may ignore the first message, and transmit the second message to the third device 130.

In some embodiments, in response to receiving, from the third device 130, a first message for requesting to disconnect the at least one connection, the first device 110 may determine whether at least one link associated with the at least one connection is present. If the at least one link is not present, the first device 110 may ignore the first message.

With the method of FIG. 6, a procedure for sidelink release may be provided.

FIG. 7 illustrates an example method 700 of communication implemented at a second device as a network device in accordance with some embodiments of the present disclosure. For example, the method 700 may be performed at the second device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the second device 120 transmits, to the first device 110, at least one of the following: a RRC reconfiguration message comprising a first indication, the first indication indicating that at least one connection between the first device and a third device is to be released; a RRC reconfiguration message indicating an indirect to direct path switch; or a RRC reconfiguration message indicating a release of at least one of a RLC configuration for relaying or bearer mapping configuration.

In some embodiments, the first indication may be comprised in the RRC reconfiguration message as an IE. In some embodiments, the IE may be associated with a second protocol layer or a third protocol layer of the first device 110. In some embodiments, the first indication may be comprised in a RRC container in the RRC reconfiguration message. In some embodiments, the RRC container may be associated with a second protocol layer or a third protocol layer of the first device 110.

In some embodiments, the second device 120 may transmit, to the first device 110, a fifth indication indicating whether a second protocol layer or a third protocol layer of the first device is triggered to perform the releasing.

In some embodiments, the first indication may comprise first information of at least one link associated with the at least one connection. In some embodiments, the first information may comprise a layer 2 identifier, PC5 link identifier or source and destination identifiers for each of the at least one link.

In some embodiments, the second device 120 may receive, from the first device 110, second information indicating that one or more links are established between the first device and the third device, and determine the at least one link based on the second information.

In some embodiments, the second device 120 may transmit, to the first device 110, a sixth indication indicating that the releasing of the connection is performed by the first device. In some embodiments, the sixth indication comprises at least one of an identity or type of the first device.

With the method of FIG. 7, a procedure of sidelink releasing may be triggered.

### Example Implementation of Device

FIG. 8 is a simplified block diagram of a device 800 that is suitable for implementing embodiments of the present disclosure. The device 800 can be considered as a further example implementation of the first device 110 or the second device 120 or the third device 130 as shown in FIG. 1. Accordingly, the device 800 can be implemented at or as at least a part of the first device 110 or the second device 120 or the third device 130.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a first device comprises circuitry configured to: receive, from a second device, a RRC reconfiguration message; and release at least one connection between the first device and a third device in response to at least one of the following: the RRC reconfiguration message comprising a first indication, the first indication indicating that the at least one connection is to be released; the RRC reconfiguration message indicating an indirect to direct path switch; or the RRC reconfiguration message indicating a release of at least one of a RLC configuration for relaying or bearer mapping configuration.

In some embodiments, the first indication is comprised in the RRC reconfiguration message as an IE. In some embodiments, the first indication is comprised in a RRC container in the RRC reconfiguration message.

In some embodiments, the circuitry may be configured to release the at least one connection by: transmitting, from a first protocol layer of the first device to a second protocol layer of the first device, a second indication indicating the at least one connection is to be released; releasing, by the second protocol layer, a set of radio bearers associated with the at least one connection; transmitting, from the second protocol layer to a third protocol layer of the first device, a third indication indicating that the at least one connection is released; and releasing, by the third protocol layer, at least one link associated with the at least one connection.

In some embodiments, the circuitry may be configured to release the at least one connection by: transmitting, from a first protocol layer of the first device to a third protocol layer of the first device, a second indication indicating the at least one connection is to be released; releasing, by the third protocol layer, at least one link associated with the at least one connection; transmitting, from the third protocol layer to a second protocol layer of the first device, a fourth indication indicating that the at least one link is released; and releasing, by the second protocol layer, a set of radio bearers associated with the at least one connection.

In some embodiments, the circuitry may be configured to release the at least one link by: transmitting, from the third protocol layer to the third device, a request for releasing the at least one link, or releasing the at least one link locally by the third protocol layer.

In some embodiments, the second indication comprises at least one of the following: an identifier of the at least one link, an identifier of a destination, or an identifier of a source and an identifier of a destination for each of the at least one link.

In some embodiments, the circuitry may be configured to transmit the second indication by one of the following: transmitting the second indication upon receipt of the RRC reconfiguration message from the second device; transmitting the second indication upon or after transmission of a RRC reconfiguration complete message; or transmitting the second indication upon or after performance of a connection reconfiguration for sidelink.

In some embodiments, the circuitry may be further configured to determine whether a second protocol layer or a third protocol layer of the first device is triggered to perform the releasing. In some embodiments, the circuitry may be configured to: receive, from the second device, a fifth indication indicating whether the releasing is triggered by the second protocol layer or the third protocol layer; and determine, based on the fifth indication, whether the releasing is triggered by the second protocol layer or the third protocol layer.

In some embodiments, the circuitry may be configured to: in accordance with a determination that the first indication is comprised in an IE or a RRC container for the second protocol layer, determine that the releasing is triggered by the second protocol layer; or in accordance with a determination that the first indication is comprised in an IE or a RRC container for the third protocol layer, determining that the releasing is triggered by the third protocol layer.

In some embodiments, the first indication comprises first information of at least one link associated with the at least one connection. In these embodiments, the circuitry may be configured to release the connection by releasing the at least one link. In some embodiments, the first information may comprise a layer 2 identifier, PC5 link identifier or source and destination identifiers for each of the at least one link.

In some embodiments, the circuitry may be further configured to transmit, to the second device, second information indicating that one or more links are established between the first device and the third device.

In some embodiments, the circuitry may be configured to release the at least one connection by: releasing the at least one connection in response to receiving, from the second device, a sixth indication indicating that the releasing of the at least one connection is performed by the first device. In some embodiments, the sixth indication may comprise at least one of an identity or type of the first device.

In some embodiments, the circuitry may be configured to release the at least one connection by: in accordance with a determination that the first indication is comprised in an IE or a RRC container for the first device or for the type of the first device, releasing the at least one connection.

In some embodiments, the circuitry may be configured to release the at least one connection by: determining whether at least one link associated with the at least one connection is present; and in accordance with a determination that the at least one link is present, releasing the at least one connection. In some embodiments, the circuitry may be further configured to: in accordance with a determination that the at least one link is not present, ignore the releasing of the at least one connection.

In some embodiments, the circuitry may be further configured to: in response to receiving, from the third device, a first message for requesting to disconnect the at least one connection after a second message for requesting to disconnect the at least one connection is transmitted to the third device, ignore the first message.

In some embodiments, the circuitry may be further configured to: in response to receiving, from the third device, a first message for requesting to disconnect the at least one connection upon generation of a second message for requesting to disconnect the at least one connection to be transmitted to the third device, cancel the second message; and transmit, to the third device, a response to the first message.

In some embodiments, the circuitry may be further configured to: in response to receiving, from the third device, a first message for requesting to disconnect the at least one connection upon generation of a second message for requesting to disconnect the at least one connection to be transmitted to the third device, ignore the first message; and transmit the second message to the third device.

In some embodiments, the circuitry may be further configured to: in response to receiving, from the third device, a first message for requesting to disconnect the at least one connection, determine whether at least one link associated with the at least one connection is present; and in accordance with a determination that the at least one link is not present, ignore the first message. In some embodiments, the first device and the third device are terminal devices, and the second device is a network device.

In some embodiments, a second device comprises a circuitry configured to: transmit, to a first device, at least one of the following: a RRC reconfiguration message comprising a first indication, the first indication indicating that at least one connection between the first device and a third device is to be released; a RRC reconfiguration message indicating an indirect to direct path switch; or a RRC reconfiguration message indicating a release of at least one of a RLC configuration for relaying or bearer mapping configuration.

In some embodiments, the first indication is comprised in the RRC reconfiguration message as an IE. In some embodiments, the IE is associated with a second protocol layer or a third protocol layer of the first device.

In some embodiments, the first indication is comprised in a RRC container in the RRC reconfiguration message. In some embodiments, the RRC container is associated with a second protocol layer or a third protocol layer of the first device.

In some embodiments, the circuitry may be further configured to: transmit, to the first device, a fifth indication indicating whether a second protocol layer or a third protocol layer of the first device is triggered to perform the releasing.

In some embodiments, the first indication comprises first information of at least one link associated with the at least one connection. In some embodiments, the first information comprises a layer 2 identifier, PC5 link identifier or source and destination identifiers for each of the at least one link.

In some embodiments, the circuitry may be further configured to: receive, from the first device, second information indicating that one or more links are established between the first device and the third device; and determine the at least one link based on the second information.

In some embodiments, the circuitry may be further configured to: transmit, to the first device, a sixth indication indicating that the releasing of the connection is performed by the first device. In some embodiments, the sixth indication comprises at least one of an identity or type of the first device. In some embodiments, the first device and the third device are terminal devices, and the second device is a network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-38. (canceled)

39. A method of communication performed by a relay user equipment (UE), comprising:
receiving, from a network device, a radio resource control (RRC) reconfiguration message; and
releasing a remote UE in a case where the RRC reconfiguration message indicating a list of remoted UEs to be released, the list of remote UEs comprises the remote UE.

40. The method of claim 39, wherein releasing the remote UE comprises:
a first protocol layer of the relay UE indicating a second protocol layer of the relay UE to trigger a PC5 unicast link release associated with the remote UE.

41. The method of claim 40, wherein releasing the remote UE further comprises:
the second protocol layer sending a link release request to the remote UE.

42. The method of claim 39, wherein the list of remote UEs being a list of destination identity (ID) s.

43. A method of communication performed by a remote user equipment (UE), comprising:
receiving, from a network device, a radio resource control (RRC) reconfiguration message; and
a first protocol layer of the remote UE indicating a second protocol layer of the remote UE to trigger a PC5 unicast link release associated with a relay UE in a case where the RRC reconfiguration message indicating an indirect to direct path switch.

44. The method of claim 43, further comprising:
the second protocol layer sending a link release request to the relay UE.

45. A method of communication performed by a relay user equipment (UE), comprising:
receiving, from a network device, a radio resource control (RRC) reconfiguration message; and
a first protocol layer of the relay UE indicating a second protocol layer of the relay UE to trigger a PC5 unicast link release.

46. The method of claim 45, further comprising:
the second protocol layer sending a link release request to the remote UE.

47. A relay user equipment (UE), comprising:
a processor configured to cause the relay UE to:
receive, from a network device, a radio resource control (RRC) reconfiguration message; and
release a remote UE in a case where the RRC reconfiguration message indicating a list of remoted UEs to be released, the list of remote UEs comprises the remote UE.

48. The relay UE of claim 47, wherein the relay UE is caused to release the remote UE by:
a first protocol layer of the relay UE indicating a second protocol layer of the relay UE to trigger a PC5 unicast link release associated with the remote UE.

49. The relay UE of claim 48, wherein the relay UE is further caused to:
send a link release request to the remote UE from second protocol layer.

50. The relay UE of claim 47, wherein the list of remote UEs being a list of destination identity (ID) s.

51. A remote user equipment (UE), comprising:
a processor configured to cause the remote UE to:
receive, from a network device, a radio resource control (RRC) reconfiguration message; and
a first protocol layer of the remote UE indicates a second protocol layer of the remote UE to trigger a PC5 unicast link release associated with a relay UE in a case where the RRC reconfiguration message indicating an indirect to direct path switch.

52. The remote UE of claim 51, wherein the remote UE is further caused to:
send a link release request to the relay UE from the second protocol layer.

53. A relay user equipment (UE), comprising:
a processor configured to cause the relay UE to:
receive, from a network device, a radio resource control (RRC) reconfiguration message; and
a first protocol layer of the relay UE indicates a second protocol layer of the relay UE to trigger a PC5 unicast link release.

54. The relay UE of claim 53, wherein the relay UE is further caused to:
send a link release request to the remote UE from the second protocol layer.
